(19) United States
(12) Patent Application Publication
(10) Pub. No.: US 2015/0111808 A1
(43) Pub. Date: Apr. 23, 2015

(54) LAUNDRY TREATMENT COMPOSITION COMPRISING A SHADING DYE AND CHELANT

(71) Applicant: The Procter & Gamble Company, Cincinnati, OH (US)

(72) Inventor: Gregory Scot MIRACLE, Liberty Township, OH (US)

(21) Appl. No.: 14/509,243

(22) Filed: Oct. 8, 2014

(30) Foreign Application Priority Data
Oct. 17, 2013 (EP) 13189078.2

(51) Int. Cl. C11D 3/42

(52) U.S. Cl. CPC C11D 3/42
USPC 510/325

(57) ABSTRACT

A liquid laundry treatment composition comprising;
a. a shading dye comprising a dye polymer comprising a chromophore covalently bound to one or more of at least three consecutive repeat units;
b. a chelating agent.

### FIELD OF THE INVENTION

The present invention is to laundry detergent compositions comprising shading dyes.

### BACKGROUND OF THE INVENTION

Shading dyes have been used previously in laundry treatment compositions. Shading dyes visually whiten textile substrates and counteract the fading and yellowing of the textiles substrates.

A problem encountered with shading dyes is dye stability in product over time. Often shading dye will break down over time affecting cleaning performance and sometimes even aesthetic appearance of the consumer product.

The Inventors have surprisingly found that a composition comprising a chelant and the specific shading dye of the present invention minimizes the level of dye break down.

### SUMMARY OF THE INVENTION

The present invention is to a liquid laundry treatment composition comprising;
a. a shading dye comprising a dye polymer comprising a chromophore covalently bound to one or more of at least three consecutive repeat units;
b. a chelating agent.

### DETAILED DESCRIPTION OF THE INVENTION

### Composition

The liquid laundry treatment composition of the present invention comprises;
a. A shading dye, comprising a dye polymer comprising a chromophore covalently bound to one or more of at least three consecutive repeat units;
b. a chelating agent.

The composition of the present invention is a liquid laundry treatment composition. The term ‘liquid laundry detergent composition’ refers to any laundry detergent composition comprising a fluid capable of wetting and treating fabric e.g., cleaning clothing in a domestic washing machine, and includes, but is not limited to, liquids, gels, pastes, dispersions and the like. The liquid composition can include solids or gases in suitably subdivided form, but the fluid composition excludes forms which are non-fluid overall, such as tablets or granules.

The liquid composition may be in the form of a unit dose article. The unit dose article of the present invention comprises a water-soluble film which fully encloses the liquid composition in at least one compartment. The unit dose article may be a multicompartment article, preferably a multicompartment pouch having a superposed orientation, i.e. wherein at least one compartment is arranged on top of another compartment.

The liquid laundry treatment composition can be used as a fully formulated consumer product, or may be added to one or more further ingredient to form a fully formulated consumer product. The liquid laundry detergent composition may be a ‘pre-treat’ composition which is added to a fabric, preferably a fabric stain, ahead of the fabric being added to a wash liquor.

The liquid laundry treatment composition can be used in a fabric hand wash operation or may be used in an automatic machine fabric wash operation.

Suitable shading dyes are described in more detail below.

Suitable chelants are described in more detail below.

### Shading Dye

The shading dyes employed in the present laundry care compositions may comprise polymeric or non-polymeric dyes, pigments, or mixtures thereof. Preferably the shading dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The shading dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The shading dye may have the following structure:

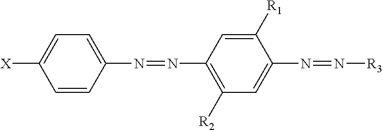

wherein:
R₁ and R₂ are independently selected from the group consisting of: H; alkyl; alkoxy; alkyleneoxy; alkyl capped alkyleneoxy; urea; and amido;
R₃ is a substituted aryl group;
X is a substituted group comprising oxygen, nitrogen or sulfonamide moiety and optionally an alkyl and/or aryl moiety, and wherein the substituent group comprises at least one alkyleneoxy chain that comprises at least four alkyleneoxy moieties.

The shading dye may have the following structure:

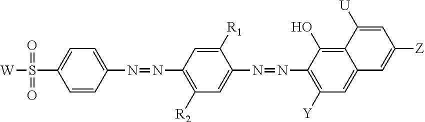

wherein:

R₁ and R₂ are independently selected from the group consisting of: H; alkyl; alkoxy; alkyleneoxy; alkyl capped alkyleneoxy; urea; and amido, preferably wherein R₁ is an alkoxy group and R₂ is an alkyl group;

U is a hydrogen, a substituted or unsubstituted amino group;

W is a substituted group comprising an amino moiety and optionally an alkyl and/or aryl moiety, and wherein the substituent group comprises at least one alkyleneoxy chain that comprises at least four alkyleneoxy moieties;

Y is a hydrogen or a sulfonic acid moiety; and

Z is a sulfonic acid moiety or an amino group substituted with an aryl group.

The liquid laundry detergent composition may comprise from 0.00001 to 3 wt %, or even from 0.00001 to 2 wt %, or even from 0.00001 to 1% or even from 0.00001% to 0.5% by weight of the composition of the shading dye.

Suitable shading dyes have the following structure:

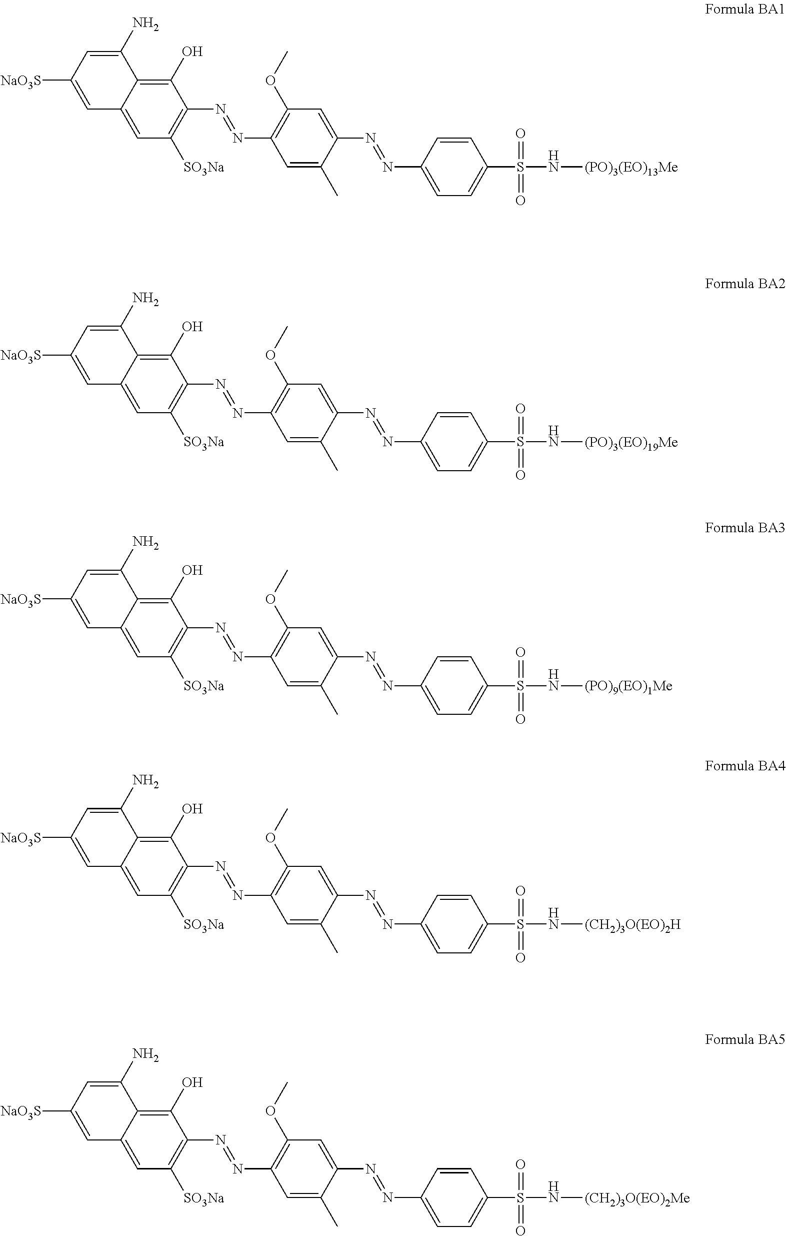

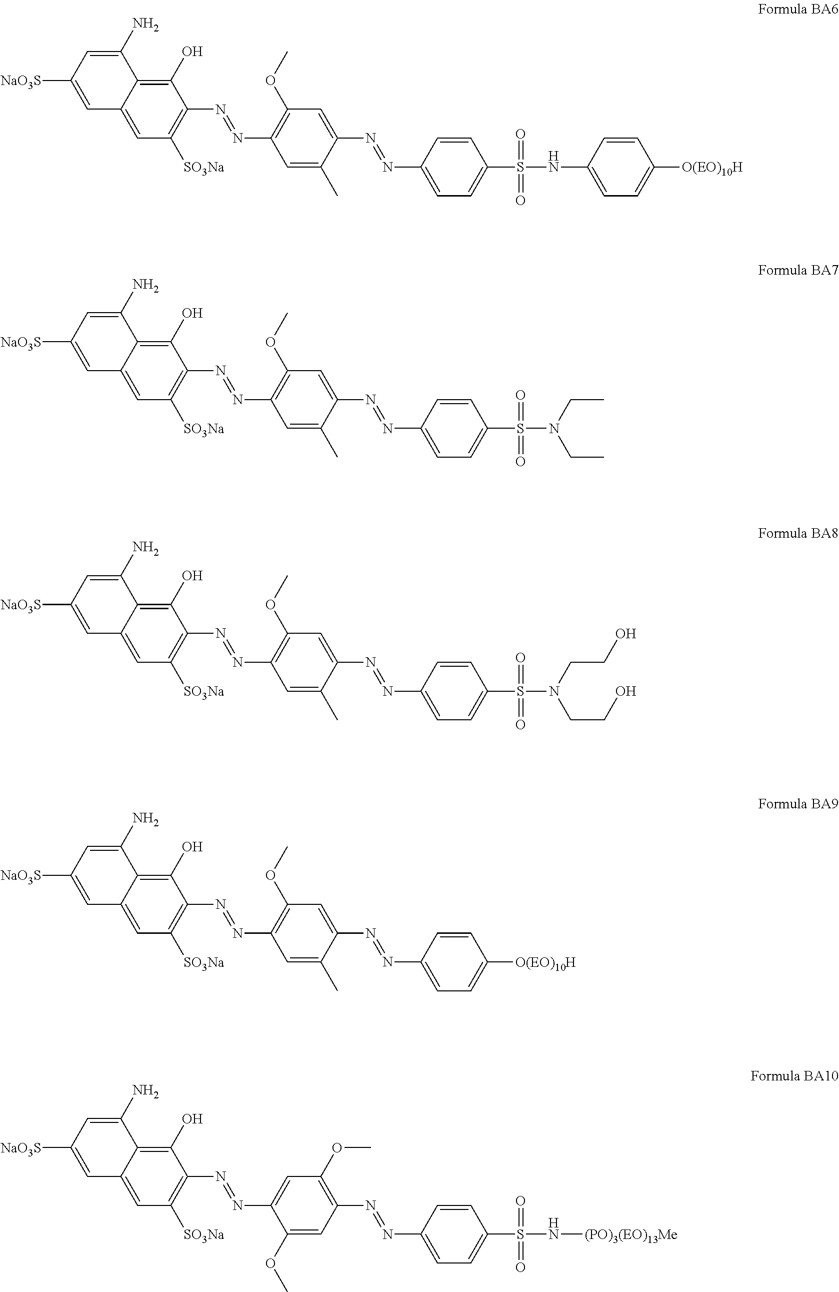

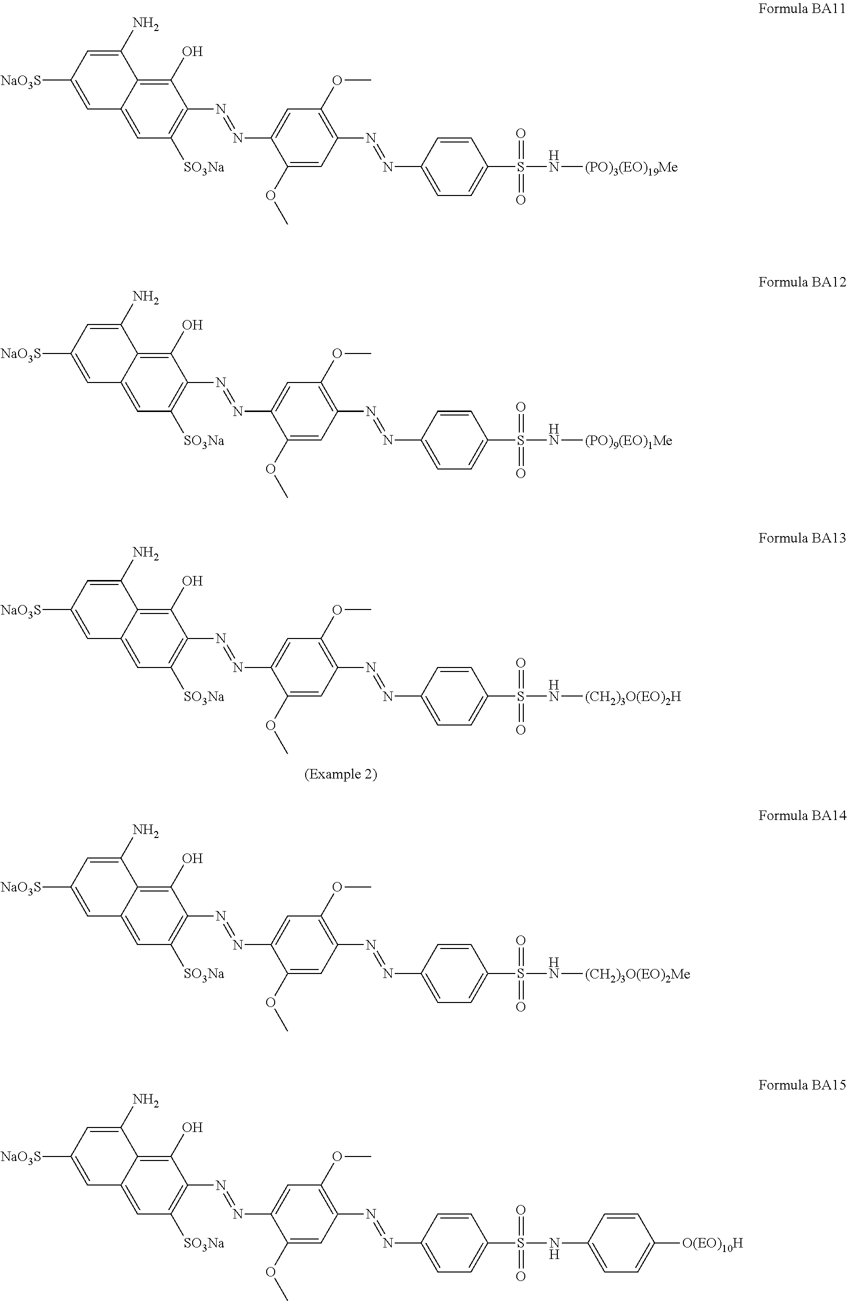

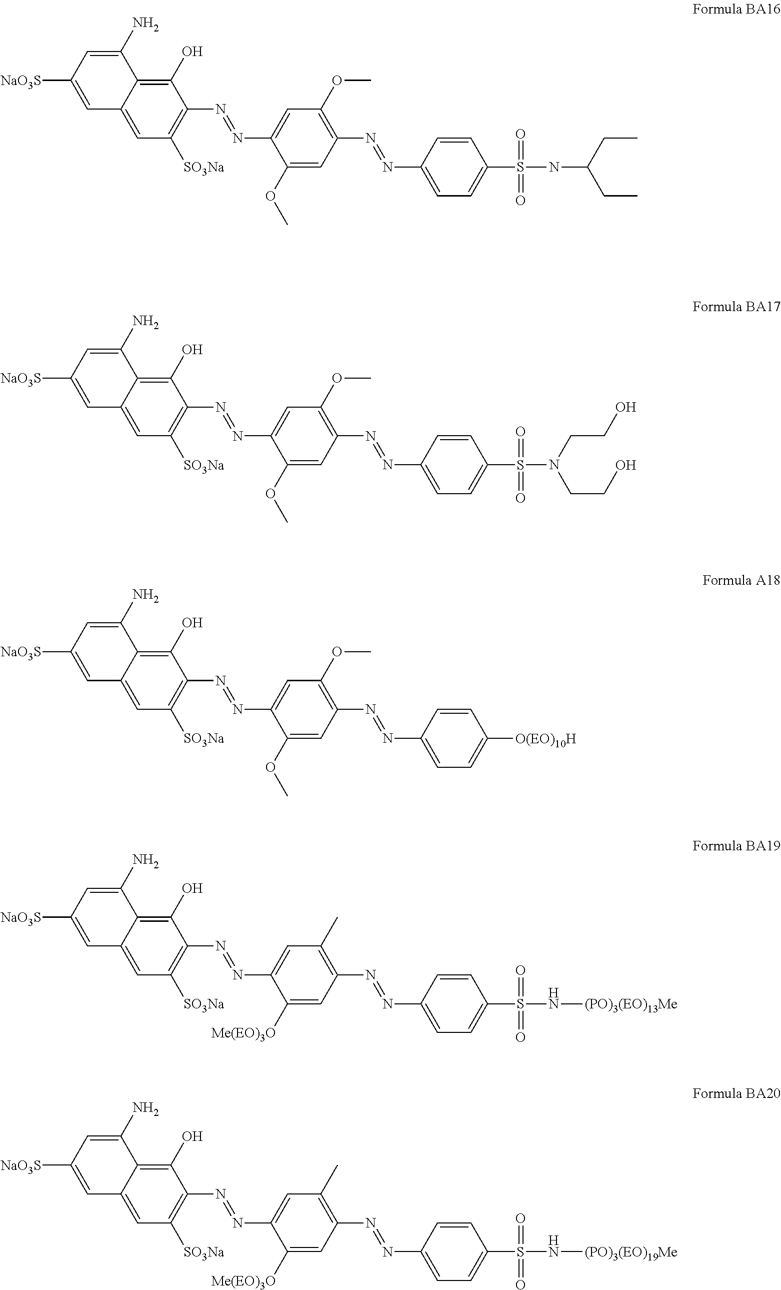

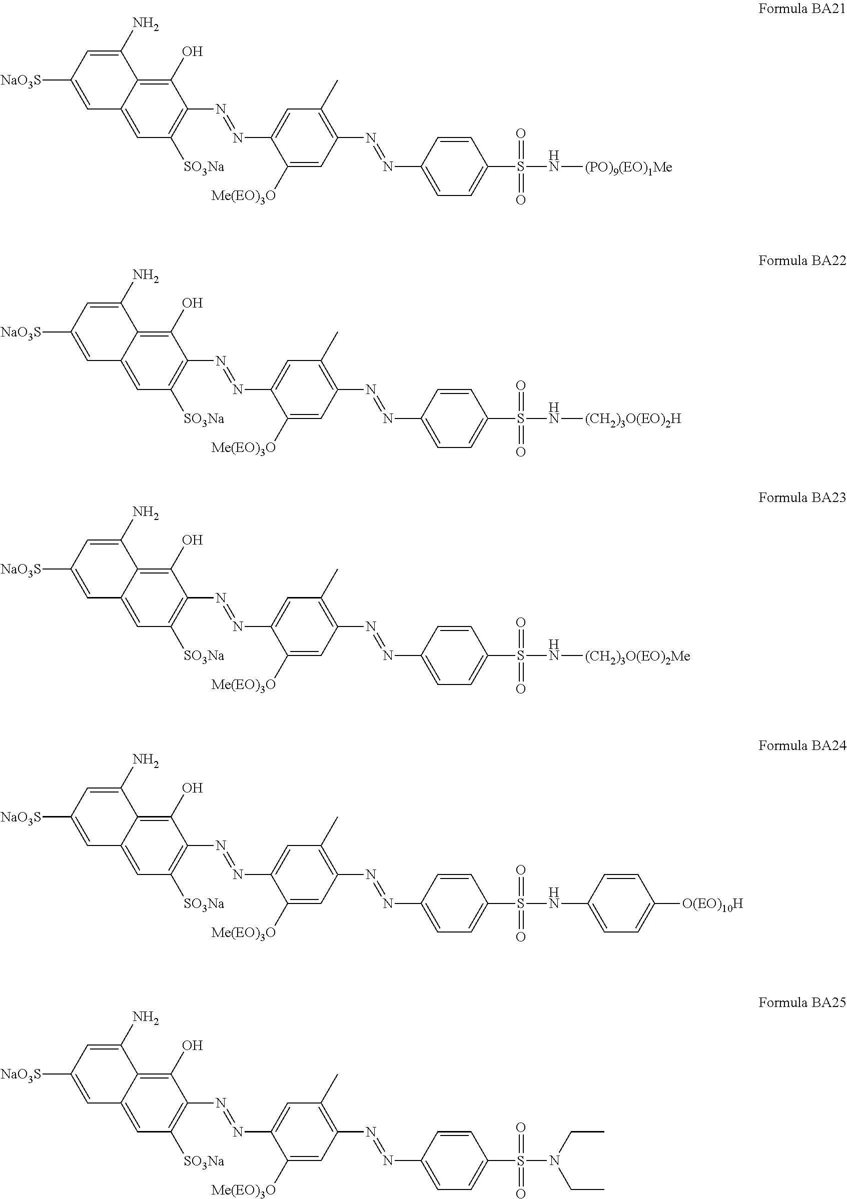

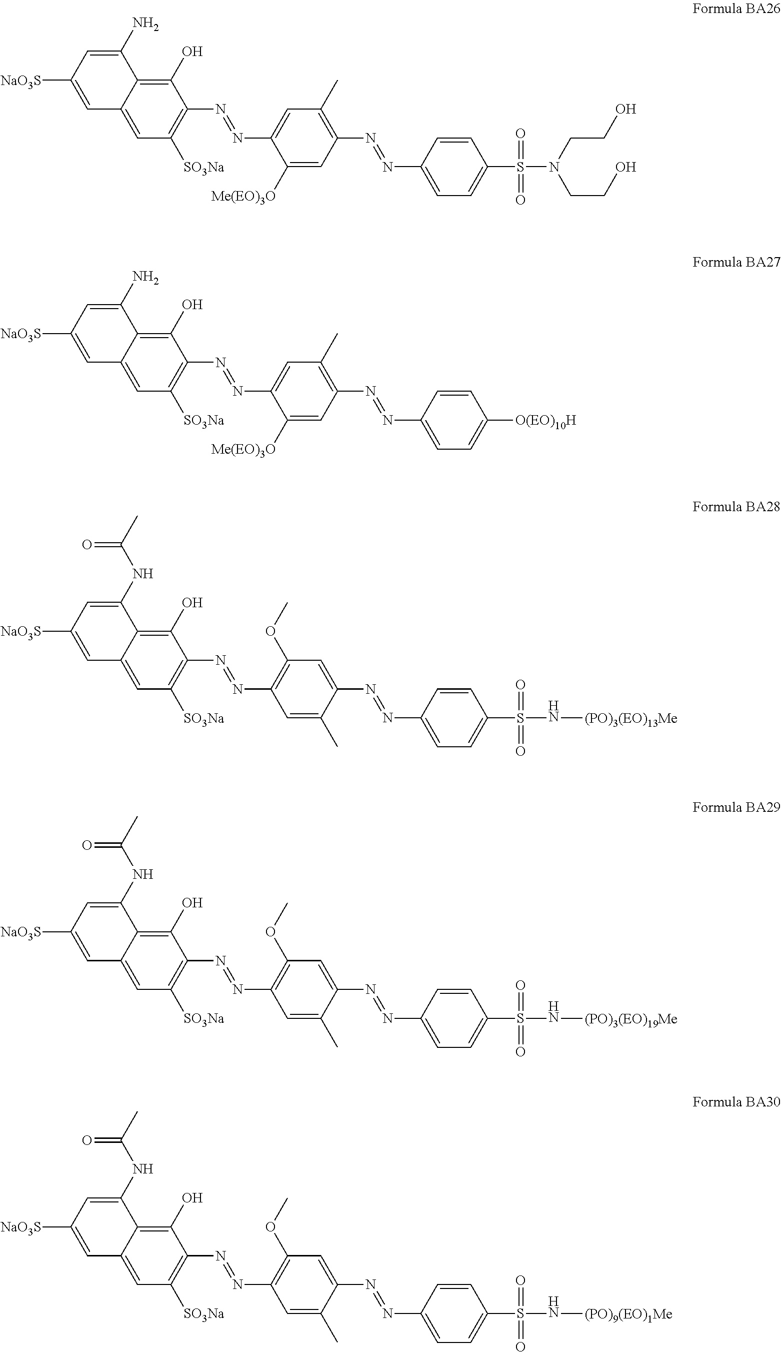

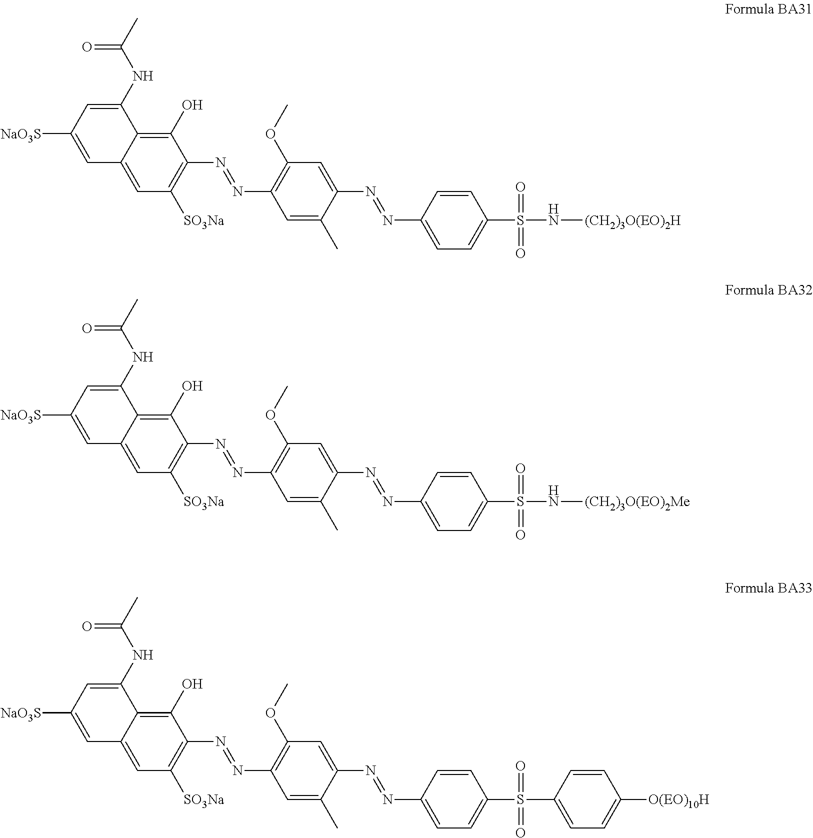

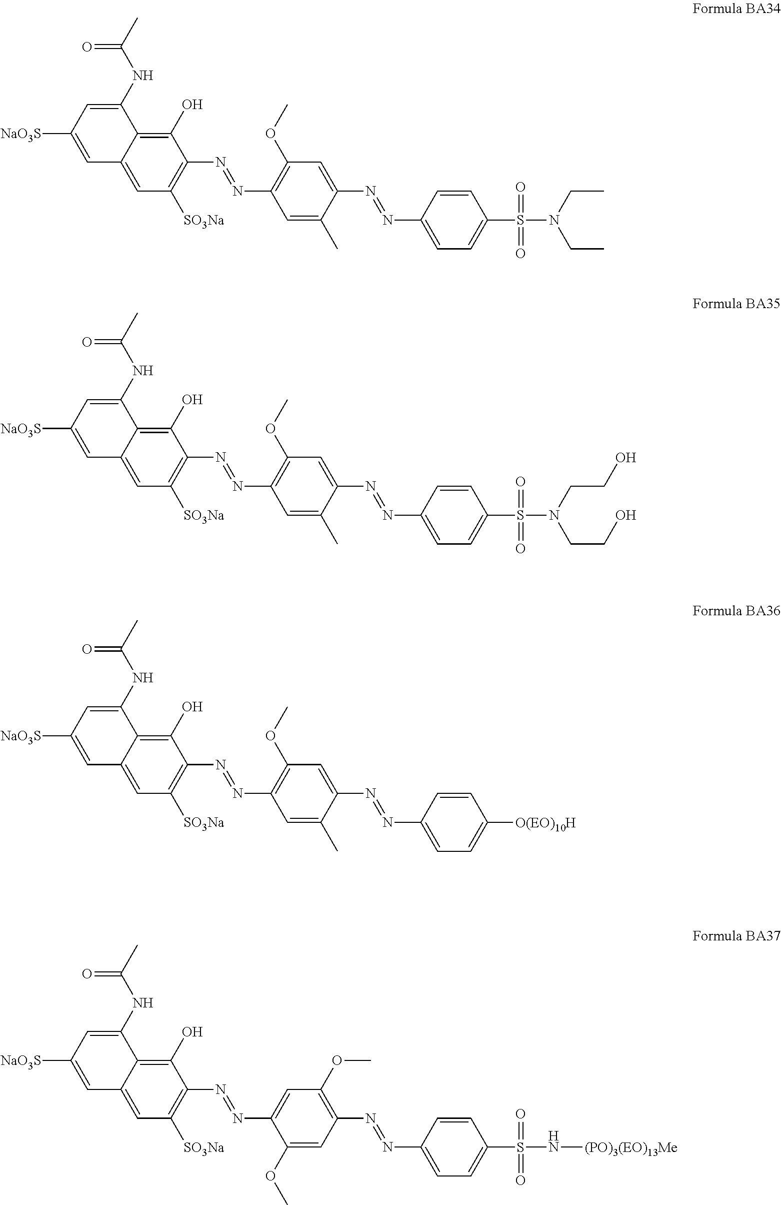

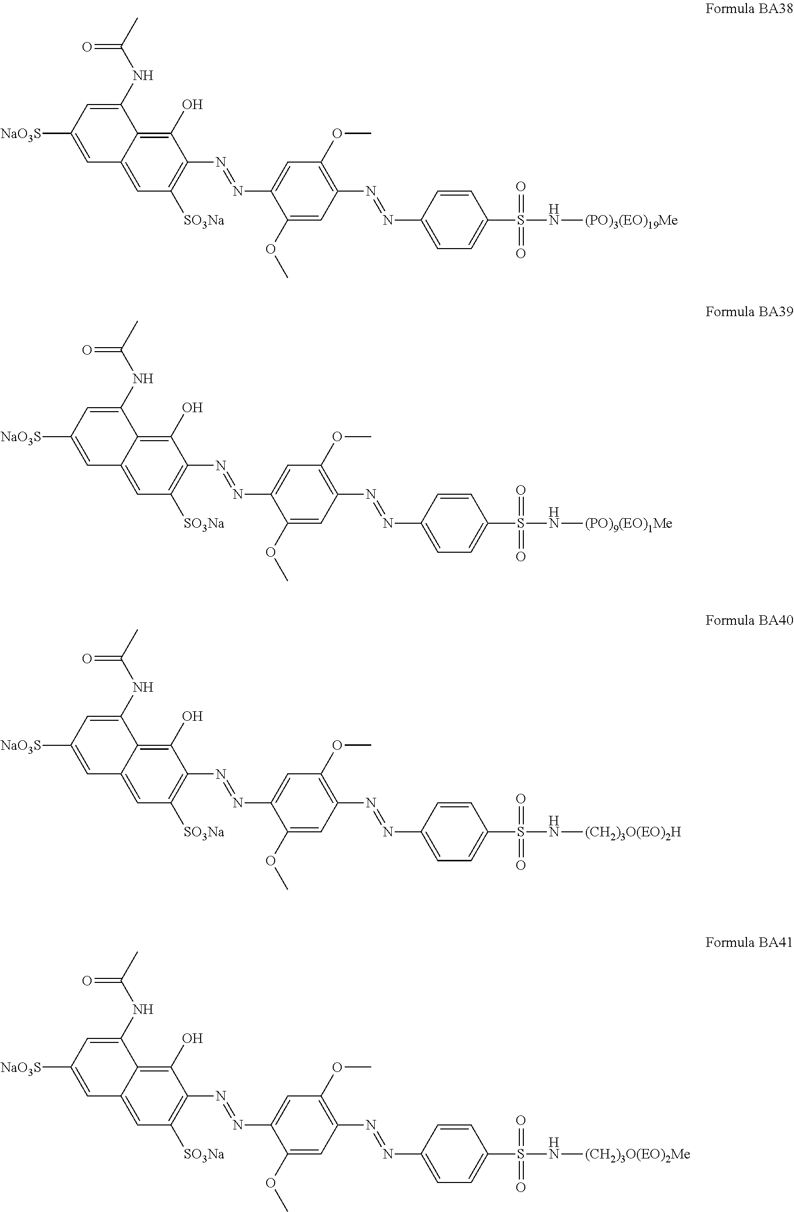

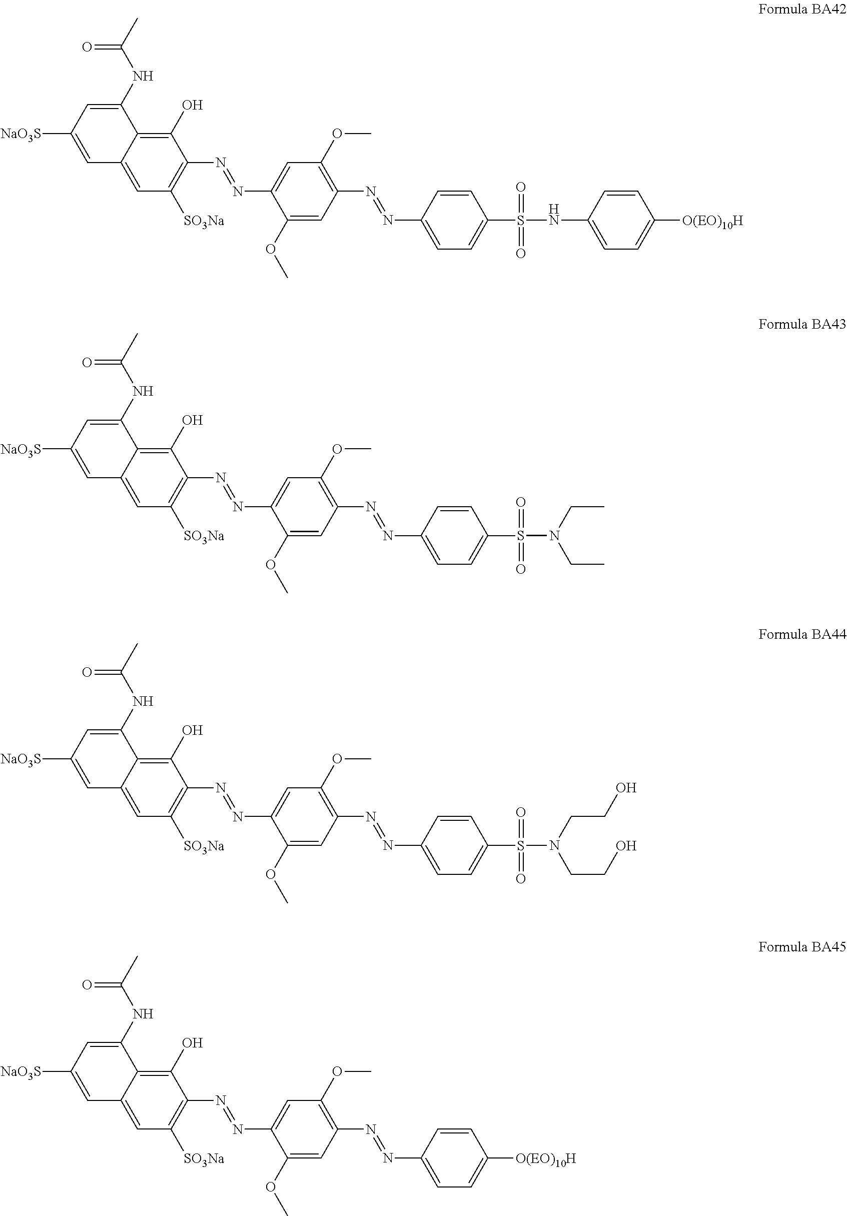

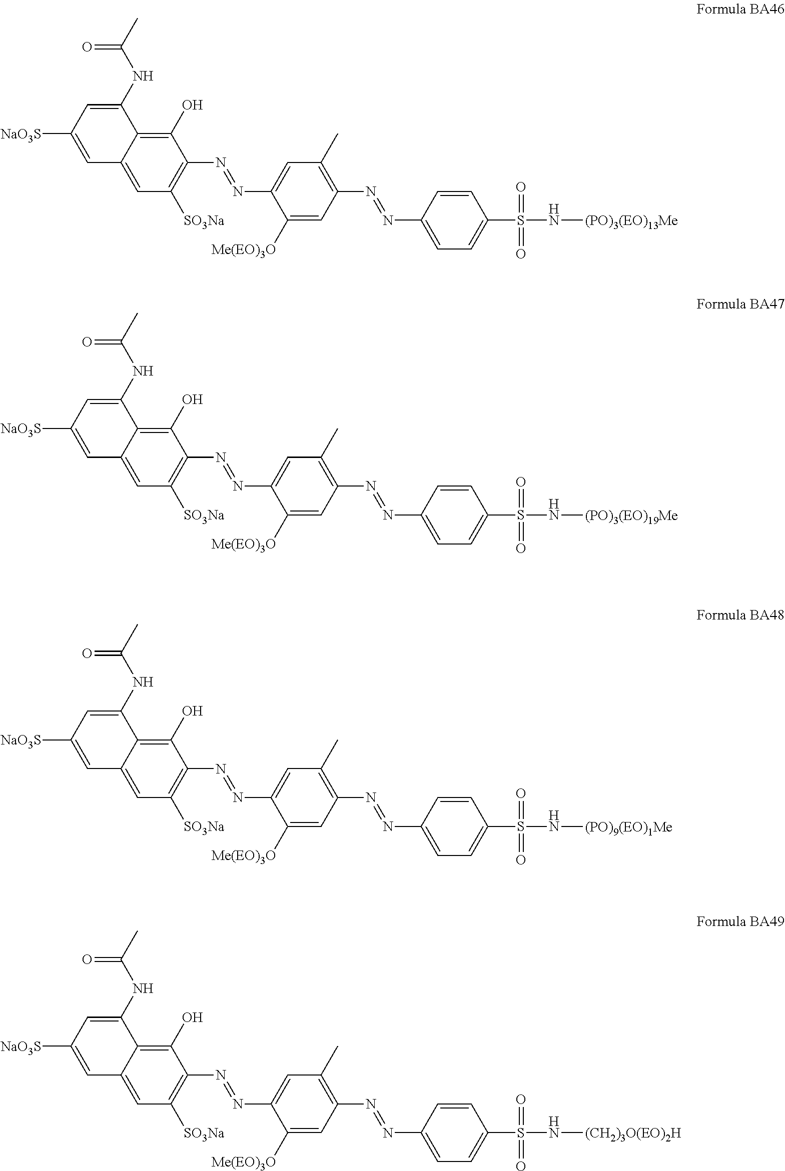

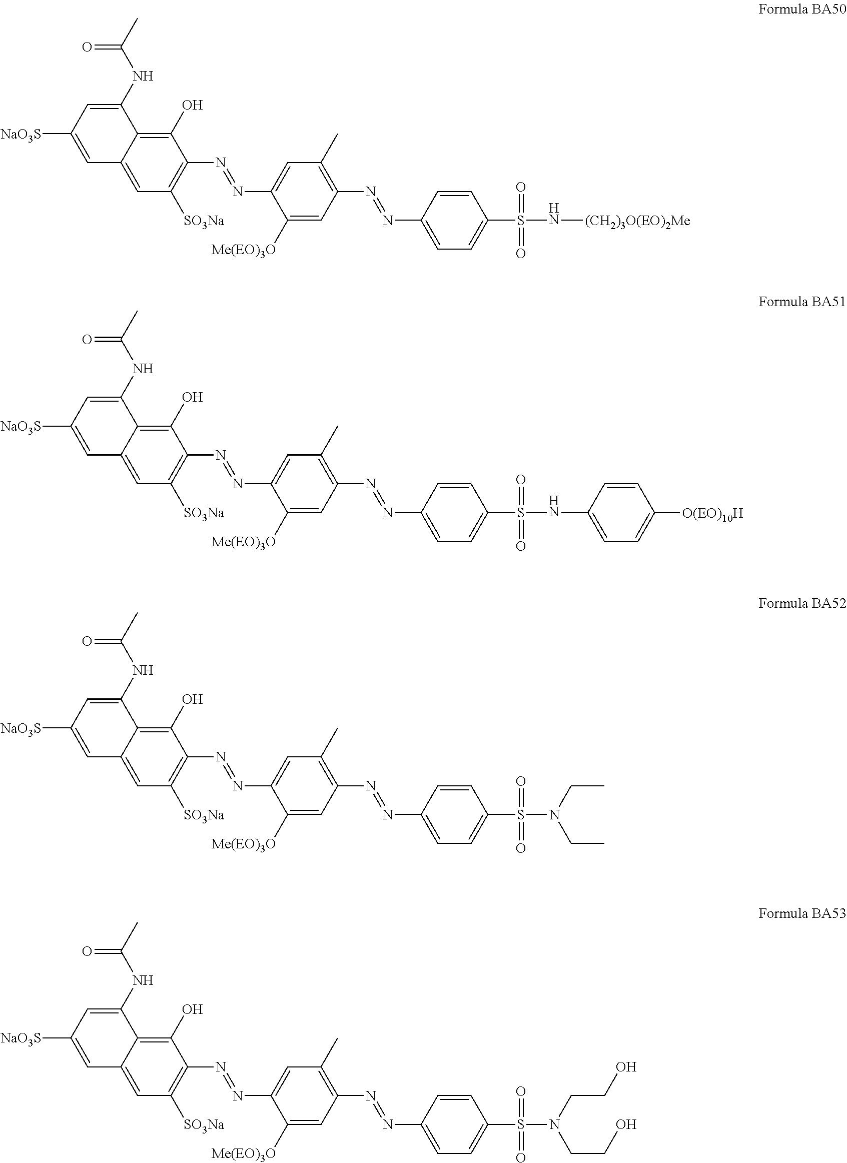

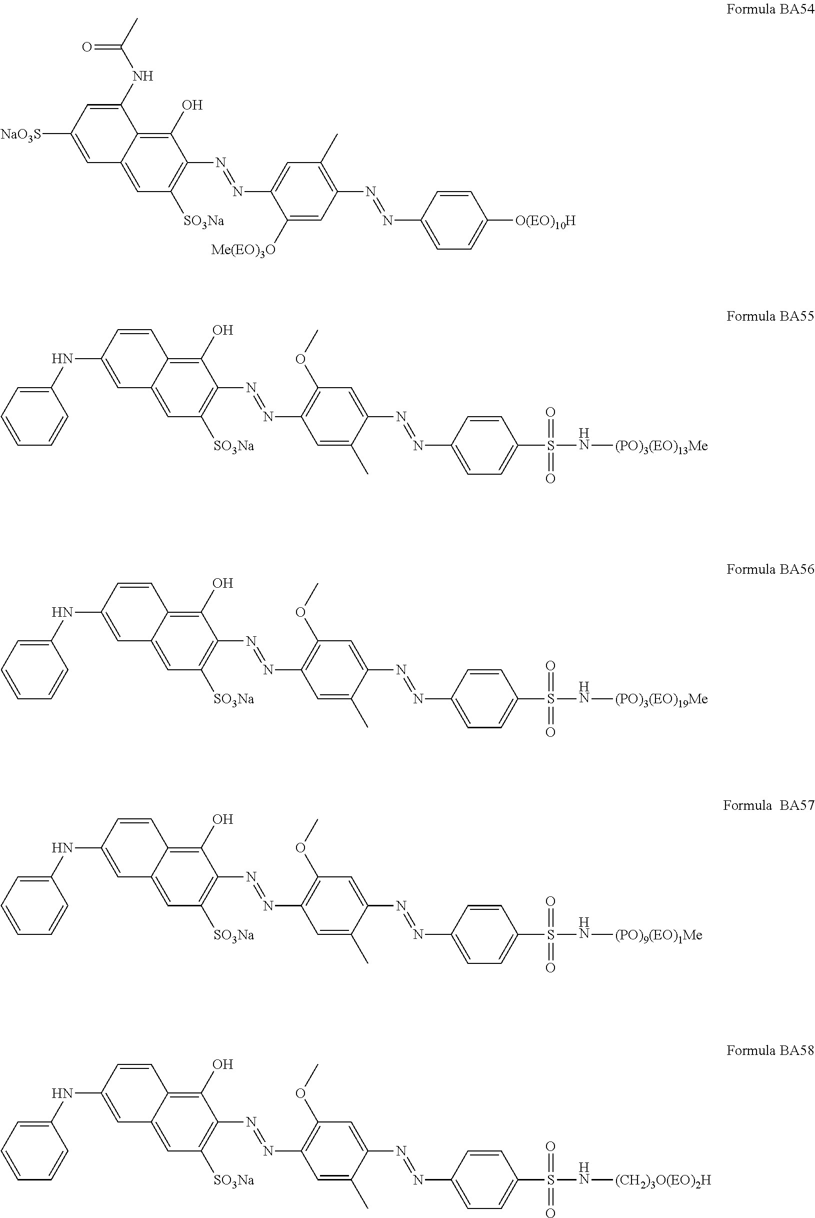

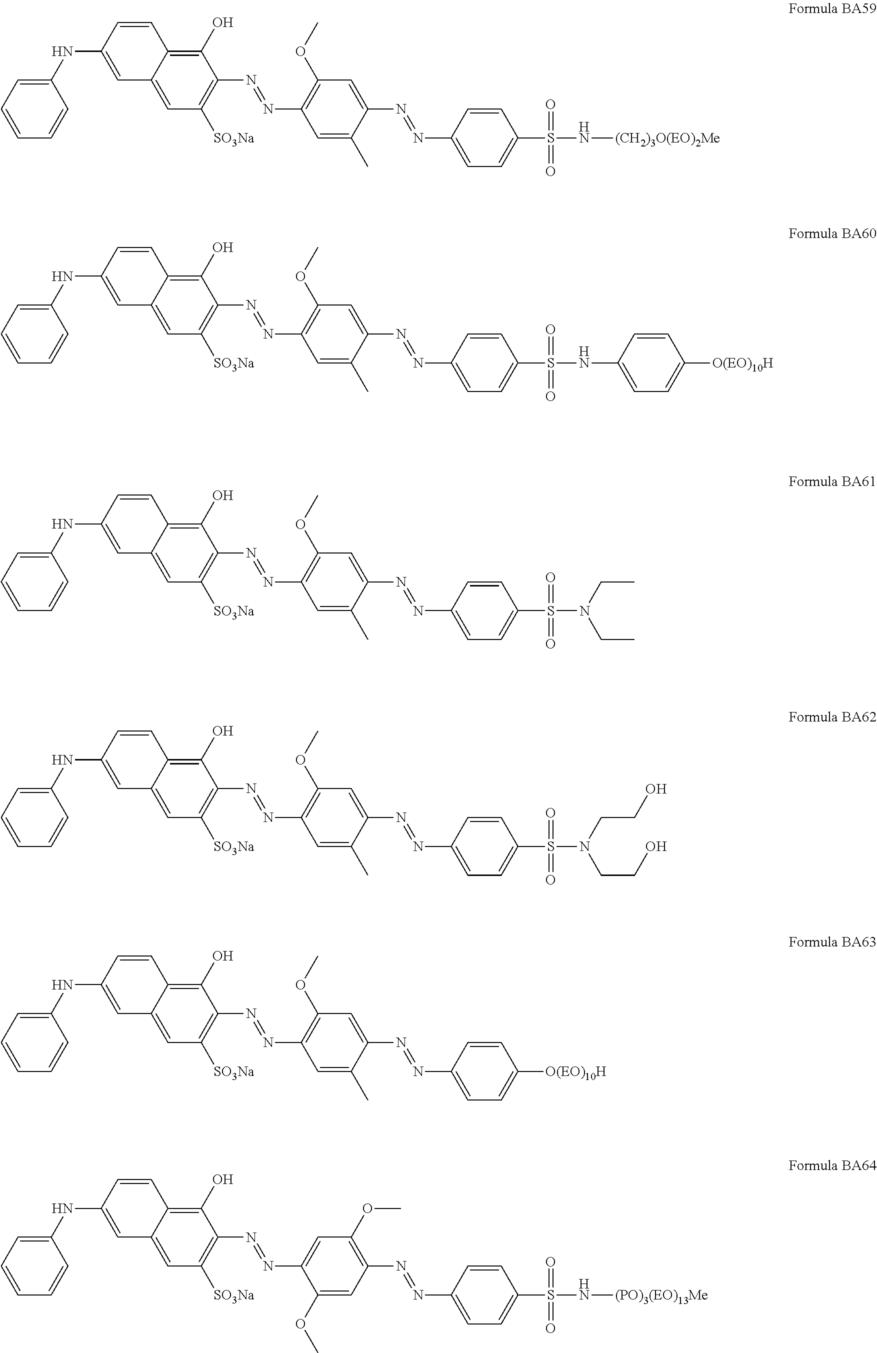

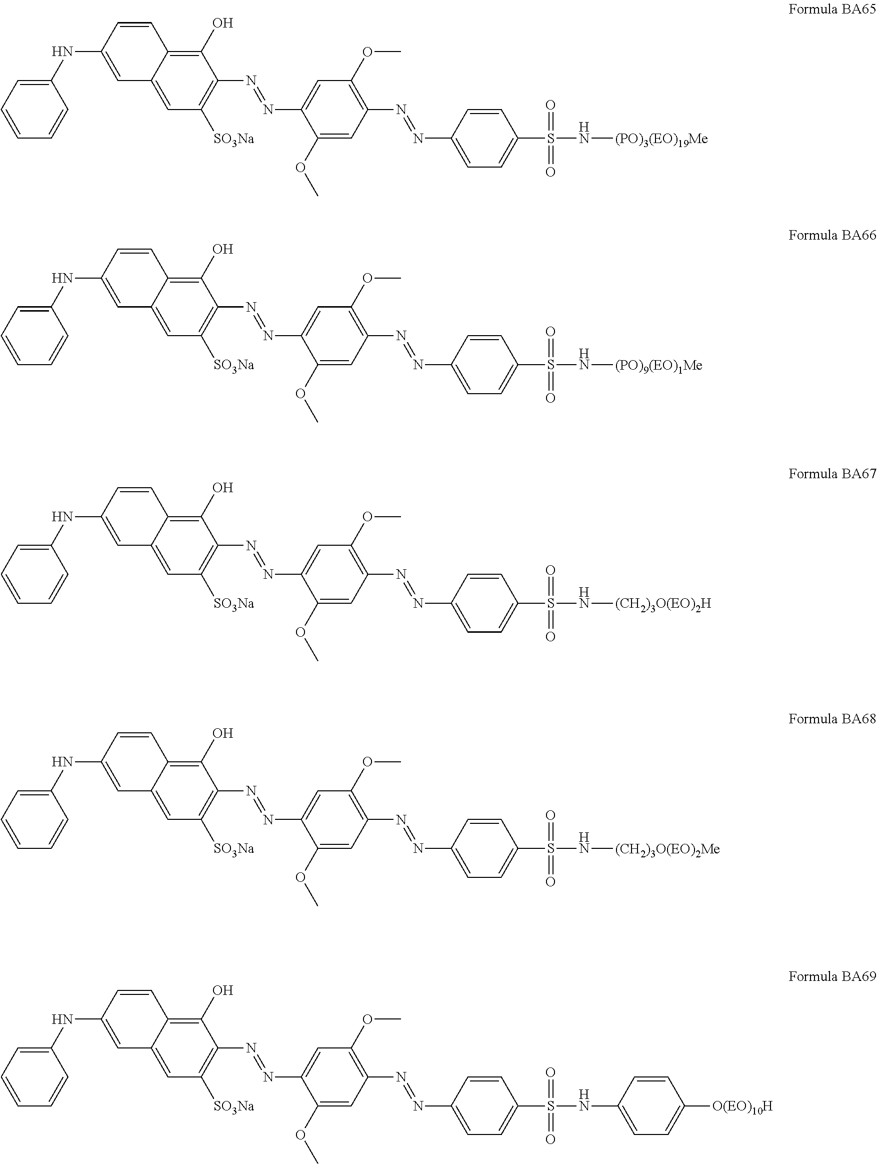

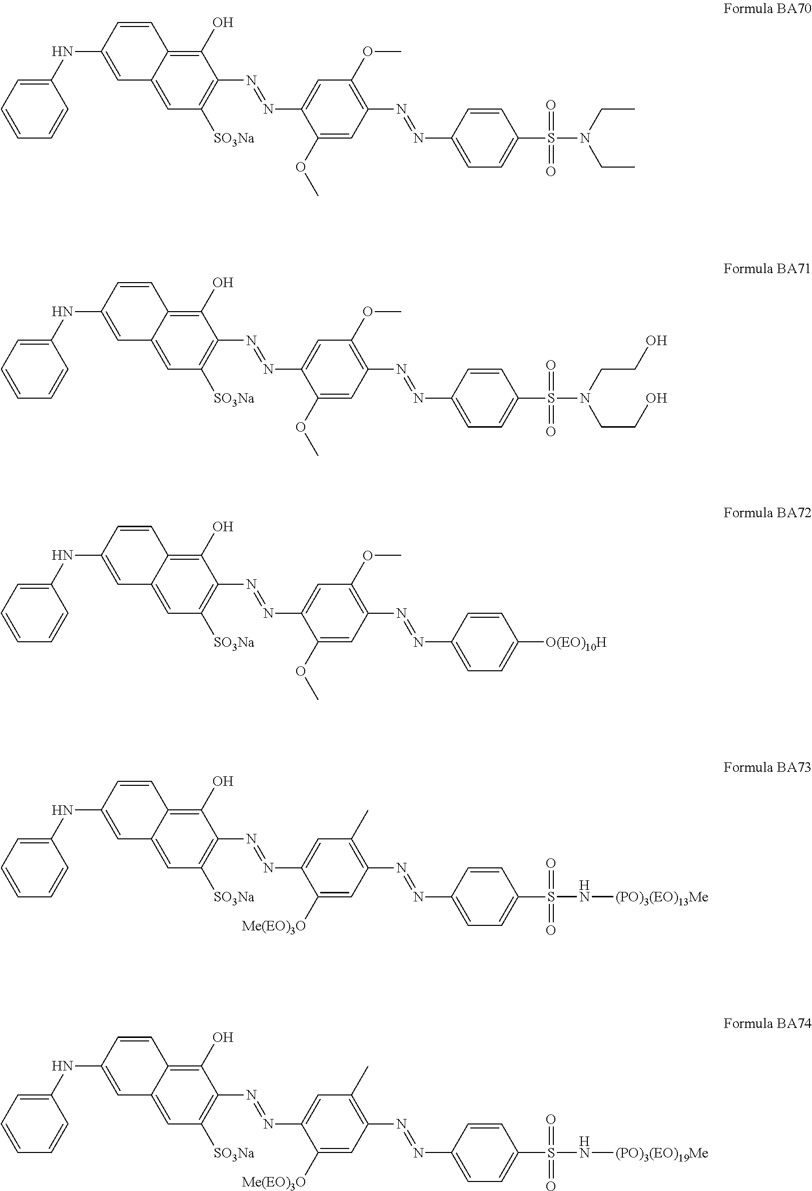

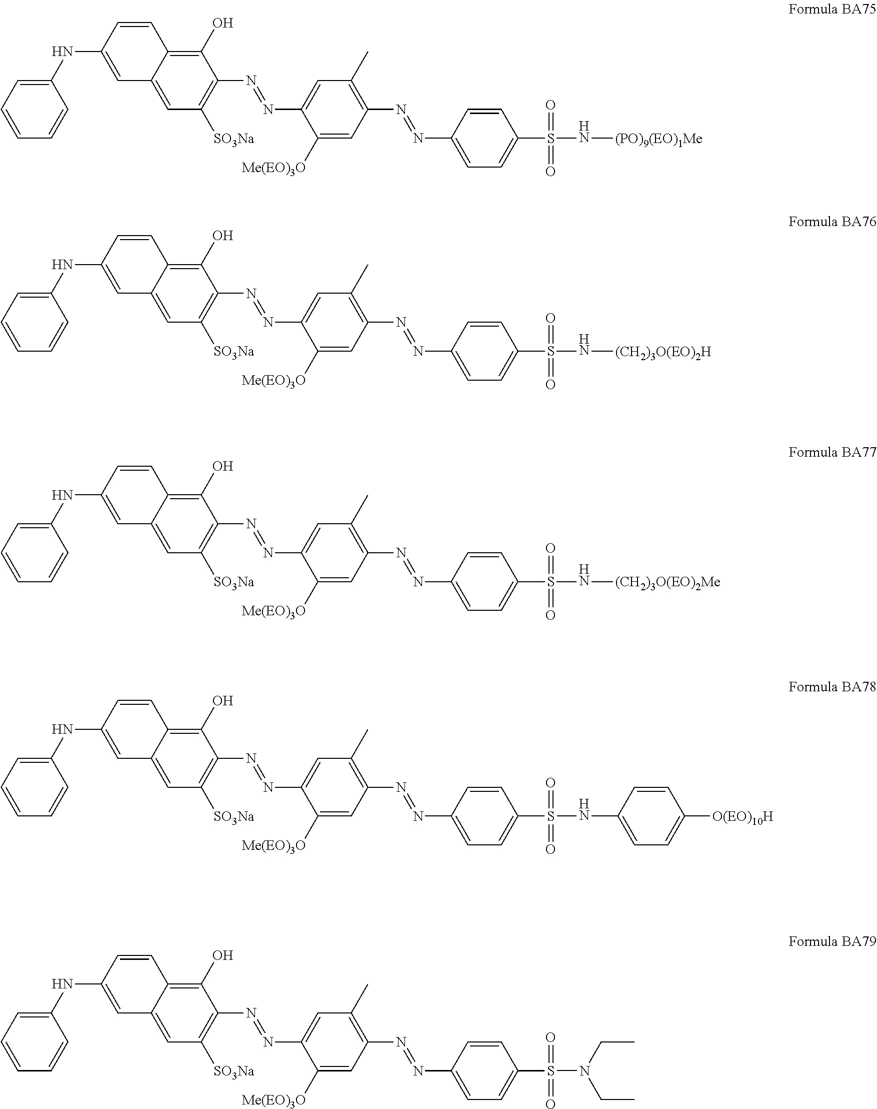

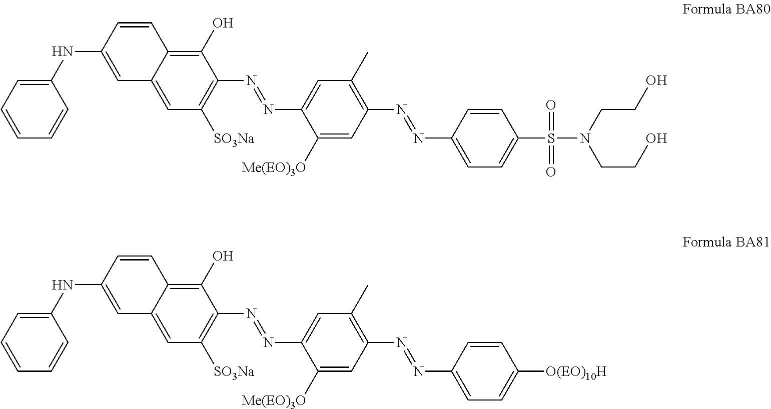

The dye may be introduced into the detergent composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

### Chelating Agent

The liquid laundry treatment compositions of the present invention comprise a chelating agent. The composition may comprise greater than 0.1 wt % or even greater than 0.5 wt % or even greater than 1 wt % or even greater than 2.5 wt % or even greater than 2.75 wt %, or even greater than 3 wt % or even greater than 5 wt % chelating agent. The composition may comprise at most 15 wt %, or even at most 12.5 wt % or even at most 10 wt % chelating agent. The terms ‘chelant’ and ‘chelating agent’ are used interdependently and mean the same thing.

The chelating agent may be a copper, iron and/or manganese chelating agents, or a mixture thereof. Suitable chelants may be selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant may be selected from ethylene diamine-N′N′-disuccinic acid (EDDS), hydroxyethane diphosphonic acid (HEDP) or mixtures thereof. The laundry detergent composition may comprise ethylene diamine-N′N′-disuccinic acid or salt thereof. The ethylene diamine-N′N′-disuccinic acid may be in S,S enantiomeric form. The composition may comprise 4,5-dihydroxy-m-benzenedisulfonic acid disodium salt, glutamic acid-N,N-diacetic acid (GLDA) and/or salts thereof, 2-hydroxypyridine-1-oxide, Triton P™ available from BASF, Ludwigshafen, Germany. Suitable chelants may also be calcium carbonate crystal growth inhibitors. Suitable calcium carbonate crystal growth inhibitors may be selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The composition may comprise a hydroxamate chelant. By ‘hydroxamate’ we herein mean hydroxamic acid or the corresponding salt. A preferred hydroxamate chelant is coco hydroxamic acid (Axis House RK 853).

### Adjunct Ingredients

While not essential for the purposes of the present invention, the non-limiting list of adjunct ingredients illustrated hereinafter are suitable for use in the laundry care compositions.

Suitable ingredient ingredients include, but are not limited to, fabric softening actives, polymers, for example cationic polymers, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments.

Preferably, the adjunct ingredient is selected from the group comprising enzymes, surfactants, perfumes, encapsulated perfume materials, soil release polymers, dye transfer inhibitors, fabric softening agents, brighteners and mixtures thereof.

### Unit Dose Article

The liquid composition may be in the form of a unit dose article. The unit dose article of the present invention comprises a water-soluble film which fully encloses the liquid composition in at least one compartment.

The fluid composition can include solids or gases in suitably subdivided form, but the fluid composition excludes forms which are non-fluid overall, such as tablets or granules. The fluid compositions preferably have densities in the range from of 0.9 to 1.3 grams per cubic centimeter, more preferably from 1.00 to 1.1 grams per cubic centimeter, excluding any solid additives, but including any bubbles, if present. The unit dose article can be of any form, shape and material which is suitable for holding the fluid composition, i.e. without allowing the release of the fluid composition, and any additional component, from the unit dose article prior to contact of the unit dose article with water. The exact execution will depend, for example, on the type and amount of the compositions in the unit dose article, the number of compartments in the unit dose article, and on the characteristics required from the unit dose article to hold, protect and deliver or release the compositions or components.

The unit dose article comprises a water-soluble film which fully encloses the fluid composition in at least one compartment. The unit dose article may optionally comprise additional compartments; said additional compartments may comprise an additional composition. Said additional composition may be fluid, solid, and mixtures thereof. Alternatively, any additional solid component may be suspended in a fluid-filled compartment. A multi-compartment unit dose form may be desirable for such reasons as: separating chemically incompatible ingredients; or where it is desirable for a portion of the ingredients to be released into the wash earlier or later. The unit dose article may comprise at least one, or even at least two, or even at least three, or even at least four, or even at least five compartments. The unit dose article may be a multicompartment article having a superposed orientation, i.e. wherein at least one compartment is arranged on top of another compartment.

The film of the unit dose article is soluble or dispersible in water, and preferably has a water-solubility of at least 50%, preferably at least 75% or even at least 95%, as measured by the method set out here after using a glass-filter with a maximum pore size of 20 microns:

50 grams±0.1 gram of pouch material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred film materials are polymeric materials. The film material can be obtained, for example, by casting, blow-moulding, extrusion or blown extrusion of the polymeric material, as known in the art. Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000. Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material. Preferred films exhibit good dissolution in cold water, meaning unheated water straight from the tap. Preferably such films exhibit good dissolution at temperatures below 25° C., more preferably below 21° C., more preferably below 15° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M9467, M8310, films described in U.S. Pat. No. 6,166,117 and U.S. Pat. No. 6,787,512 and PVA films of corresponding solubility and deformability characteristics. Further preferred films are those describes in US2006/0213801, WO 2010/119022 and U.S. Pat. No. 6,787,512.

Preferred water soluble films are those resins comprising one or more PVA polymers, preferably said water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 cP (cP mean centipoise), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20.deg. C. All viscosities specified herein in cP should be understood to refer to the viscosity of 4% aqueous polyvinyl alcohol solution at 20.deg. C, unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as lone as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin can still further include one or more additional PVA polymers that have a viscosity in a range of about 10 to about 40 cP and a degree of hydrolysis in a range of about 84% to about 92%.

When the PVA resin includes a first PVA polymer having an average viscosity less than about 11 cP and a polydispersity index in a range of about 1.8 to about 2.3, then in one type of embodiment the PVA resin contains less than about 30 wt. % of the first PVA polymer. Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt. % of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt. % of a first PVA polymer that has a viscosity in a range of about 10 to about 15 cP and a degree of hydrolysis in a range of about 84% to about 92%. Another type of embodiment is characterized by the PVA resin including about 45 to about 55 wt. % of the first PVA polymer that has a viscosity in a range of about 10 to about 15 cP and a degree of hydrolysis in a range of about 84% to about 92%. The PVA resin can include about 15 to about 60 wt. % of the second PVA polymer that has a viscosity in a range of about 20 to about 25 cP and a degree of hydrolysis in a range of about 84% to about 92%. One contemplated class of embodiments is characterized by the PVA resin including about 45 to about 55 wt. % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

Preferably the PVA resin that has a weighted, average degree of hydrolysis (.deg.) between about 80 and about 92%, or between about 83 and about 90%, or about 85 and 89%. For example, H .deg. for a PVA resin that comprises two or more PVA polymers is calculated by the formula H.deg.=(Wi−H,) where ½ is the weight percentage of the respective PVA polymer and H, is the respective degrees of hydrolysis. Still further it is desirable to choose a PVA resin that has a weighted log average viscosity between about 10 and about 25, or between about 12 and 22, or between about 13.5 and about 20. The .micro. for a PVA resin that comprises two or more PVA polymers is calculated—YW−In/ by the formula .micro.=e (1 ) where .micro.[ ] is the viscosity for the respective PVA polymers.

Yet further, it is desirable to choose a PVA resin that has a Resin Selection Index (RSI) in a range of 0.255 to 0.315, or 0.260 to 0.310, or 0.265 to 0.305, or 0.270 to 0.300, or 0.275 to 0.295, preferably 0.270 to 0.300. The RSI is calculated by the formula (w[t]\micro.[{]−A|)/.Sigma. ((W)iMi)> wherein .micro.[(] is seventeen, /, is the average viscosity each of the respective PVA polymers, and Wi is the weight percentage of the respective PVA polymers.

Even more preferred films are water soluble copolymer films comprising a least one negatively modified monomer with formula V:

[Y]-[G]ₙ Formula V

wherein Y represents a vinyl alcohol monomer and G represents a monomer comprising an anionic group and the index n is an integer of from 1 to 3. G can be any suitable comonomer capable of carrying of carrying the anionic group, more preferably G is a carboxylic acid. G is preferably selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid and mixtures thereof.

The anionic group of G is preferably selected from the group consisting of OSO₃M, SO₃M, CO₂M, OCO₂M, OPO₃M₂, OPO₃HM and OPO₂M. More preferably anionic group of G is selected from the group consisting of OSO₃M, SO₃M, CO₂M, and OCO₂M. Most preferably the anionic group of G is selected from the group consisting of SO₃M and CO₂M.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including water, to be delivered to the wash water, for example organic polymeric dispersants, etc.

### Examples

A dual compartment pouch manufactured using 0.7 g of a 76 μm thick water soluble film (M8779, MonoSol, Merrillville Ind., USA) is thermoformed to prepare a dual compartment pouch measuring 44 mm by 44 mm. The pouch is filled with 18 mL (19.0 g) of product A (table 1), in the first compartment, and 3.0 mL (1.6 g) of one of product B1, B2 or B3 (table 1) is filled in the second compartment.

| Ingredients | A | B1 | B2 | B3 |
|---|---|---|---|---|
| Linear C₉-C₁₅ | 18.5 | 18.5 | 18.5 | 18.5 |
| Alkylbenzene | | | | |
| sulfonic acid | | | | |
| C₁₂₋₁₄ alkyl | 14.6 | 14.6 | 14.6 | 14.6 |
| ethoxylate | | | | |
| Citric Acid | 0.6 | 0.6 | 0.6 | 0.6 |
| Top palm kernel | 6.0 | 6.1 | 6.1 | 6.1 |
| fatty acid | | | | |
| C12-14 alkyl | 8.5 | 8.6 | 8.6 | 8.6 |
| ethoxy 3 sulfate | | | | |
| Chelant | 0.6 | 0.6 | 0.6 | 0.6 |
| Sodium hydrogen | 0.4 | 0.1 | 0.1 | 0.1 |
| sulfite | | | | |
| Polymer | 6.0 | 6.0 | 6.0 | 6.0 |
| Enzymes | 2.0 | 0.0 | 0.0 | 0.0 |
| Hydrogenated | 0.15 | 0.15 | 0.15 | 0.15 |
| castor oil | | | | |
| Perfume | 1.8 | 0.0 | 0.0 | 0.0 |
| Propanediol | 15.0 | 16.0 | 16.0 | 16.0 |
| Glycerol | 5.0 | 6.0 | 6.0 | 6.0 |
| Water | 10.0 | 10.0 | 10.0 | 10.0 |
| Shading Dye | — | 0.0002 | 0.001 | 0.01 |
| Monoethanol amine | neutralize | neutralize | neutralize | neutralize |
| or NaOH (or | to pH to | to pH to | to pH to | to pH to |
| mixture thereof) | about 7.4 | about 7.4 | about 7.4 | about 7.4 |
| Additives, Minor | To 100% | To 100% | To 100% | To 100% |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry treatment composition comprising;
a. a shading dye comprising a dye polymer comprising a chromophore covalently bound to one or more of at least three consecutive repeat units;
b. a chelating agent.

2. A liquid laundry treatment composition according to claim 1, wherein the repeat units are derived from alkenes, epoxides or mixtures thereof.

3. A liquid laundry treatment composition according to claim 2, wherein the repeat units are C2-C4 alkoxy groups.

4. A liquid laundry treatment composition according to claim 2, wherein the repeat units are C2-C4 ethoxy groups

5. A liquid laundry treatment composition according to claim 1, wherein the shading dye has the following structure: 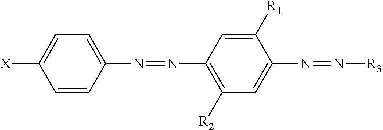
wherein:
R₁ and R₂ are independently selected from the group consisting of: H; alkyl; alkoxy; alkyleneoxy; alkyl capped alkyleneoxy; urea; and amido;
R₃ is a substituted aryl group;
X is a substituted group comprising oxygen, nitrogen or sulfonamide moiety and optionally an alkyl and/or aryl moiety, and wherein the substituent group comprises at least one alkyleneoxy chain that comprises at least four alkyleneoxy moieties.

6. A liquid laundry treatment composition according to claim 5, wherein the shading dye has the following structure: 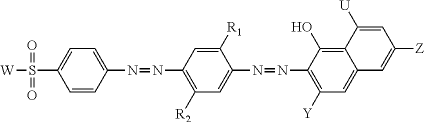
wherein:
R₁ and R₂ are independently selected from the group consisting of: H; alkyl; alkoxy; alkyleneoxy; alkyl capped alkyleneoxy; urea; and amido;
U is a hydrogen, a substituted or unsubstituted amino group;
W is a substituted group comprising an amino moiety and optionally an alkyl and/or aryl moiety, and wherein the substituent group comprises at least one alkyleneoxy chain that comprises at least four alkyleneoxy moieties;
Y is a hydrogen or a sulfonic acid moiety; and
Z is a sulfonic acid moiety or an amino group substituted with an aryl group.

7. A liquid laundry treatment composition according to claim 6, wherein R₁ is an alkoxy group and R₂ is an alkyl group.

8. A liquid laundry treatment composition according to claim 1, comprising greater than about 0.1 wt % chelating agent.

9. A liquid laundry treatment composition according to claim 8, comprising greater than about 0.5 wt % chelating agent.

10. A liquid laundry treatment composition according to claim 9, comprising greater than about 2.75 wt % chelating agent.

11. A liquid laundry treatment composition according to claim 1 comprising from about 0.00001 to about 3 wt % by weight of the composition of the shading dye.

12. A liquid laundry treatment composition according to claim 11 comprising from about 0.00001 to about 2 wt % by weight of the composition of the shading dye.

13. A liquid laundry treatment composition according to claim 12 comprising from about 0.00001% to about 0.5% by weight of the composition of the shading dye.

14. A liquid laundry treatment composition according to claim 1 wherein the chelating agent is a copper, iron and/or manganese chelating agent, or a mixture thereof.

15. A liquid laundry treatment composition according to claim 1, wherein the chelating agent is selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof.

16. A liquid laundry treatment composition according to claim 1, wherein the chelating agent is a hydroxamate chelant.

17. A liquid laundry treatment composition according to claim 1 comprising an adjunct ingredient, selected from the group comprising enzymes, surfactants, perfumes, encapsulated perfume materials, soil release polymers, dye transfer inhibitors, fabric softening agents, brighteners and mixtures thereof.

18. A liquid laundry treatment composition according to claim 1 wherein the liquid laundry detergent composition is enclosed with a water-soluble film to form a water-soluble unit dose article.

19. A liquid laundry treatment composition according to claim 18, wherein the unit dose article is a multicompartment unit dose article, preferably a superposed multicompartment unit dose article.

20. A liquid laundry treatment composition according to claim 19, wherein the multicompartment unit dose article is a superposed multicompartment unit dose article.
